(19) United States
(12) Patent Application Publication
(10) Pub. No.: US 2026/0249975 A1
(43) Pub. Date: Aug. 27, 2026

(54) METHOD FOR MANUFACTURING A CURVED CELLULAR STRUCTURE USING RIGID TUBES, AND CELLULAR STRUCTURE THUS OBTAINED

(71) Applicant: Airbus Operations SAS, TOULOUSE (FR)

(72) Inventor: Christophe PERRIER, TOULOUSE (FR)

(21) Appl. No.: 19/532,615

(22) Filed: Feb. 6, 2026

(30) Foreign Application Priority Data
Feb. 24, 2025 (FR) FR2501897

(51) Int. Cl. B64C 1/40; B32B 3/12; B32B 27/30; B64D 33/02

(52) U.S. Cl. CPC B64C 1/40; B32B 3/12; B32B 27/30; B64D 2033/0206

(57) ABSTRACT

A method for manufacturing a cellular structure of a sound attenuating panel by manufacturing ducts from a rigid thermoplastic material, placing the ducts on a tool that comprises, for each duct, a core connected to a base, each duct being fitted onto a core, the first end thereof being in contact with the base, placing a flexible layer made from a thermoplastic material against the second ends of the ducts, heating and flat-pressing in order to fuse the flexible layer and the second ends of the ducts so as to form the cellular structure, and demolding the cellular structure. Also a tool for performing the method, a cellular structure and a sound attenuating panel.

### CROSS-REFERENCES TO RELATED APPLICATIONS

This application claims the benefit of French Patent Application Number FR2501897 filed on Feb. 24, 2025, the entire disclosure of which is incorporated herein by way of reference.

### FIELD OF THE INVENTION

The present application relates to a method for manufacturing a curved cellular structure using rigid tubes, a cellular structure thus obtained, and a sound attenuating panel comprising at least one such cellular structure.

### BACKGROUND OF THE INVENTION

According to one embodiment of the prior art, a powerplant comprises a nacelle and a dual-flow turbine engine positioned inside the nacelle. Some surfaces of the nacelle and the turbine engine comprise sound attenuating panels to attenuate noise annoyance. According to one embodiment shown in FIG. 1, a sound attenuating panel 10 comprises at least one permeable layer 12, at least one cellular structure 14 and a solid layer 16. In the remainder of the description, a layer is said to be permeable if it is porous or comprises openings or holes that pass through it.

Such a sound attenuating panel 10 uses the principle of a quarter-wave resonator. The cellular structure 14 thus has cells 14.1 the volume of which is adjusted as a function of the frequency range of the sound waves to be attenuated.

According to one configuration, the sound attenuating panel 10 can comprise two superposed cellular structures, separated by a permeable layer.

The sound attenuating panel 10 comprises an aerodynamic surface that generally has a complex shape.

According to one embodiment of the prior art, the permeable layer 12, the solid layer 16 and the cellular structure or structures 14 are made from a thermosetting composite material.

Sound attenuating panels made from a thermosetting composite material are difficult to recycle.

In order to make sound attenuating panels easier to recycle, the permeable layer 12, the solid layer 16 and the cellular structure or structures 14 can be made from a single material, in particular a thermoplastic material.

However, cellular structures 14 made from a thermoplastic material are rigid and can be difficult to form into a complex shape.

### SUMMARY OF THE INVENTION

The present invention aims to overcome all or some of the drawbacks of the prior art.

To this end, the invention relates to a method for manufacturing a cellular structure of a sound attenuating panel, said cellular structure comprising ducts that define cells, each duct extending between first and second ends, said manufacturing method comprising a step of manufacturing the ducts from a rigid thermoplastic material.

According to the invention, the manufacturing method comprises:
a. a step of placing the ducts on a tool that comprises at least one base and, for each duct, a core connected to the base, each duct being fitted onto one of the cores and the first end thereof being in contact with the base,
b. a step of placing a flexible layer made from a thermoplastic material against the second ends of the ducts,
c. a step of heating and flat-pressing in order to fuse the flexible layer and the second ends of the ducts so as to form the cellular structure,
d. a step of demolding the cellular structure.

This method makes it possible to obtain a cellular structure made from a recyclable thermoplastic material that can easily be formed into a complex geometry.

According to another feature, each core has an identical transverse cross-section to the inner transverse cross-section of the duct that it holds and/or a substantially identical or slightly shorter length than the duct that it holds.

According to another feature, during the step of heating and flat-pressing, a temperature increase greater than or equal to the melting temperature of the thermoplastic material of the ducts and of the flexible layer is produced at an interface between the flexible layer and the second ends of the ducts, with sufficient pressure being exerted to fuse the interface.

The invention also relates to a tool for implementing a method for manufacturing a cellular structure of a sound attenuating panel according to one of the preceding features, characterized in that the tool comprises:
a. at least one base having a substantially flat upper surface,
b. for each duct of the cellular structure, a core connected to the base,
c. at least one heating and pressing system configured to heat a flexible layer and at least one of the ends of the ducts of the cellular structure and to press the flexible layer against the ends of the ducts.

According to another feature, the heating and pressing system comprises at least one heating plate that has a lower surface substantially parallel to the upper surface of the base, and at least one actuator configured to press the lower surface of the heating plate against the flexible layer.

The invention also relates to a cellular structure of a sound attenuating panel obtained using a manufacturing method according to one of the preceding features, and to a sound attenuating panel comprising at least one such cellular structure.

Finally, the invention relates to a method for manufacturing a sound attenuating panel, comprising:
a. a step of placing a cellular structure obtained using a manufacturing method according to one of the preceding features against a first structure among a structure permeable to at least one sound wave and a solid layer impermeable to sound waves,
b. a step of placing a second structure, different from the first structure among the permeable structure and the solid layer, against the first ends of the ducts of the cellular structure,
c. a step of assembling the permeable structure, the cellular structure and the solid layer in order to obtain the fusing of the first structure with the flexible layer of the cellular structure and of the second structure with the first ends of the ducts of the cellular structure.

### BRIEF DESCRIPTION OF THE DRAWINGS

Further features and advantages will become apparent on reading the following description of the invention, which is given by way of example only, with reference to the appended drawings, in which:

FIG. 1 is a longitudinal cross-section of part of a sound attenuating panel illustrating an embodiment of the prior art,

FIG. 2 is a side view of an aircraft,

FIG. 3 is a longitudinal half cross-section of a powerplant of an aircraft,

FIG. 4 is a longitudinal cross-section of part of a sound attenuating panel comprising a cellular structure made from a thermoplastic material illustrating one embodiment of the invention,

FIG. 5 is a perspective view of a tool for manufacturing a cellular structure illustrating one embodiment of the invention,

FIG. 6 is a perspective view of the tool shown in FIG. 5 after a step of placing ducts that define the cells of a cellular structure illustrating one embodiment of the invention,

FIG. 7 is a perspective view of the tool shown in FIG. 5 after a step of placing a flexible layer illustrating one embodiment of the invention,

FIG. 8 is a perspective view of the tool shown in FIG. 5 after a step of heating in order to connect the ducts and the flexible layer illustrating one embodiment of the invention,

FIG. 9 is a perspective view of the cellular structure obtained by virtue of the tool shown in FIG. 5 after a demolding step illustrating one embodiment of the invention,

FIG. 10 is a perspective view of the cellular structure shown in FIG. 9 after a forming step illustrating one embodiment of the invention,

FIG. 11 is a transverse cross-section of a cellular structure illustrating a first embodiment of the invention,

FIG. 12 is a transverse cross-section of a cellular structure illustrating a second embodiment of the invention.

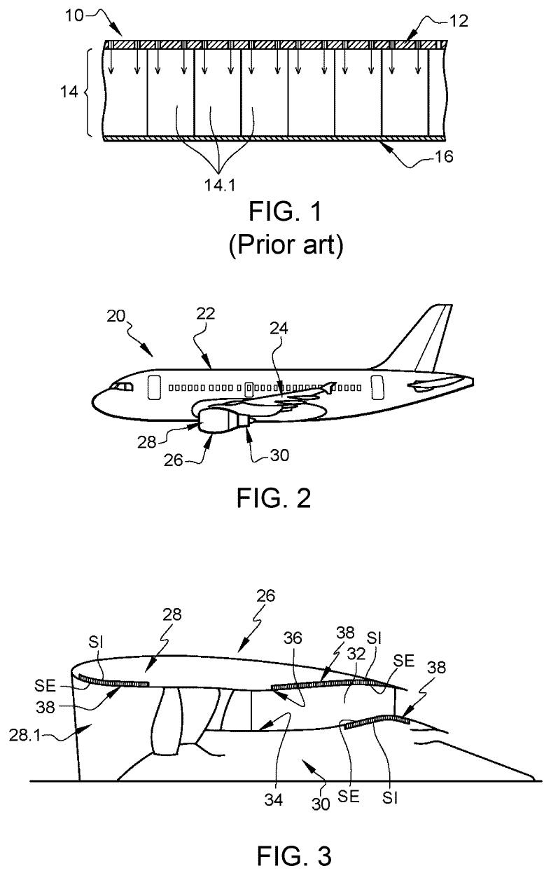

### DETAILED DESCRIPTION OF THE PREFERRED EMBODIMENTS

According to an embodiment shown in FIG. 2, an aircraft 20 comprises a fuselage 22, two wings 24 positioned on either side of the fuselage 22, and powerplants 26 fastened under the wings 24. Each powerplant 26 comprises a nacelle 28 and a turbine engine 30 positioned inside the nacelle 28.

According to one embodiment shown in FIG. 3, the powerplant 26 comprises an air intake 28.1, a secondary discharge duct 32, channeling a secondary air flow, that is defined by an inner wall 34 (also known as an IFS or inner fixed structure) and by an outer wall 36 (also known as an OFS or outer fixed structure).

According to one configuration, the air intake 28.1, the inner wall 34 or the outer wall 36 comprises at least one sound attenuating panel 38 that has an outer surface SE in contact with the secondary air flow and an inner surface SI opposite the outer surface SE.

Although it is described as applied to a secondary discharge duct 32, the invention is not limited to this application. The sound attenuating panel 38 can thus be positioned on any skin that has an outer surface SE in contact with an exterior medium Ext in which sound waves propagate during operation, such as for example a lip and an air intake duct of an aircraft nacelle, a fan casing of an aircraft nacelle or any other surface of the powerplant 26 or the aircraft 20. Regardless of the configuration, the aircraft 20 comprises at least one sound attenuating panel 38.

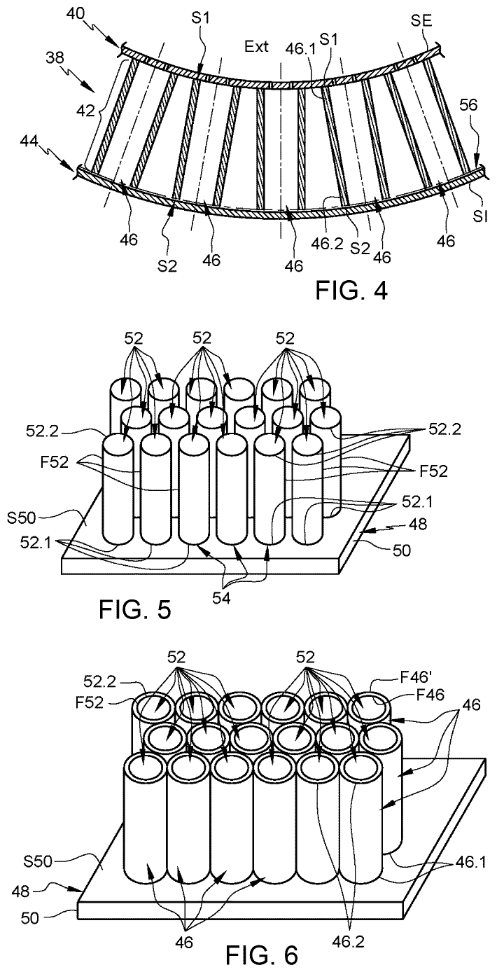

According to one embodiment shown in FIG. 4, a sound attenuating panel 38 comprises, from the outer surface SE towards the inner surface SI, a permeable structure 40, one face of which forms the outer surface SE, at least one cellular structure 42, and a solid layer 44, one face of which forms the inner surface SI.

The solid layer 44 comprises at least one thin plate, made from metal or a composite material, that is impermeable to sound waves.

The permeable structure 40, also referred to as the acoustically resistive layer, can be made from metal or a composite material and comprise one or more layers. The permeable structure 40 is permeable to at least one sound wave propagating in the exterior medium Ext.

The permeable structure 40 and the solid layer 44 are not described in further detail as they can be identical to those of the prior art.

According to one configuration shown in FIG. 4, a sound attenuating panel 38 comprises a single cellular structure 42 between the permeable structure 40 and the solid layer 44. According to another configuration, the sound attenuating panel 38 comprises, between the permeable structure 40 and the solid layer 44, a plurality of cellular structures 42 superposed on each other and separated from each other by a permeable structure, also referred to as a septum, or a plurality of juxtaposed cellular structures 42.

Regardless of the embodiment, the sound attenuating panel 38 comprises at least one cellular structure 42 interposed between a structure 40 permeable to at least one sound wave and a solid layer 44 impermeable to sound waves.

The cellular structure 42 extends between a first surface S1 in contact with or oriented towards the permeable structure 40 and a second surface S2 in contact with or oriented towards the solid layer 44. The first and second surfaces S1, S2 are substantially (i.e., +/−10%) parallel to each other. In the remainder of the description, a longitudinal direction is a direction perpendicular to at least one of the first and second surfaces S1, S2. A transverse plane is a plane perpendicular to the longitudinal direction.

The cellular structure 42 comprises a plurality of ducts 46 that each extend between first and second ends 46.1, 46.2 situated respectively level with the first and second surfaces S1, S2.

These ducts 46 are made from a thermoplastic composite material.

According to the embodiments shown in FIGS. 4 to 11, the ducts 46 have circular transverse cross-sections.

Of course, the invention is not limited to these transverse cross-sections. The ducts could thus have transverse cross-sections in the form or an oblong, triangle, rhomboid or any other shape.

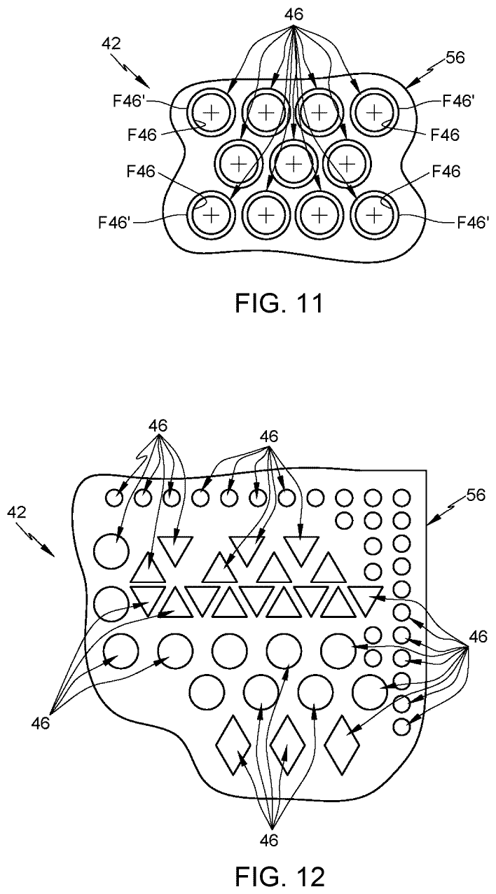

According to one configuration shown in FIG. 11, the ducts 46 of a single cellular structure 42 all have identical cross-sections. According to another configuration shown in FIG. 12, the ducts 46 of a single cellular structure 42 have different cross-sections.

According to one embodiment shown in FIG. 11, the ducts 46 of a single cellular structure 42 are evenly distributed over the entire surface of the cellular structure 42. According to another embodiment shown in FIG. 12, the ducts 46 of a single cellular structure 42 are unevenly distributed. The cellular structure 42 thus comprises at least a first zone that has a low density of ducts 46 and at least a second zone that has a second density of ducts 46 that is greater than the first density.

Each duct 46 comprises an inner face F46 and an outer face F46′. Each duct 46 has an inner transverse cross-section corresponding to the transverse cross-section of the inner face F46.

According to one embodiment, each duct 46 comprises a thermoplastic resin matrix and reinforcing fibers embedded in the matrix.

The density or densities of the ducts 46, the shape or shapes of the transverse cross-section of the ducts 46 and the dimensions (lengths and inner transverse cross-sections) of the ducts 46 are determined as a function of the features sought for the sound attenuating panel 38.

A method for manufacturing the cellular structure 42 uses a tool 48 configured to hold the ducts 46.

This tool 48 comprises at least one base 50 that has a substantially flat upper surface S50 and, for each duct 46, a core 52 that extends between first and second ends 52.1, 52.2, the first end 52.1 being rigidly connected to the base 50, and the second end 52.2 being at a distance from the base 50. According to one configuration, the base 50 and the cores 52 are integrally formed in a single piece.

According to one configuration, at least one core 52 is a separate element from the base 50 and connected thereto by a connection 54. According to one arrangement, this connection 54 is a removable connection. This arrangement makes it possible to use the same base 50 and install thereon cores 52 as a function of the arrangement and shapes of the ducts 46 of the cellular structure 42 to be produced.

Each core 52 has a side face F52 that has a transverse cross-section and extends from the first end 52.1 to the second end 52.2. According to one specific feature, each core 52 has an identical transverse cross-section to the inner face of the duct 46 that it holds. When each duct 46 is fitted without play onto the corresponding core 52, it is thus completely immobilized in a transverse plane relative to the base 50.

According to one configuration, each core 52 has a substantially (i.e. +/−10%) identical or slightly shorter length (distance separating its first and second ends 52.1, 52.2) than the duct 46 that it holds. As illustrated in FIG. 6, when each duct 46 is positioned on the tool 48, its first end 46.1 is thus in contact with the base 50 and its second end 46.2 is flush with the second end 52.2 of the core 52. The second end 46.2 of each duct 46 is situated in the same plane as the second end 52.2 of the core 52 around which the duct 46 is positioned. As a variant, the second end 52.2 of each core 52 is situated in a plane that is slightly offset towards the base 50 relative to a plane passing through the second ends 46.2 of the ducts 46.

According to the invention, the cellular structure 42 comprises at least one flexible layer 56 connected to the second ends 46.2 of the ducts 46. This flexible layer 56 is made from a thermoplastic material. According to one embodiment, the flexible layer 56 is a film made from a thermoplastic material. According to another embodiment, the flexible layer 56 comprises at least one fabric coated with a thermoplastic resin or embedded in a thermoplastic resin. Regardless of the embodiment, the flexible layer 56 is sufficiently supple to conform to the geometry of a complex surface.

According to one embodiment, the tool 48 comprises at least one heating and pressing system 58 configured to heat the flexible layer 56 and at least the second ends 46.2 of the ducts 46 and to press the flexible layer 56 against the second ends 46.2 of the ducts 46. According to one configuration, the heating and pressing system 58 comprises at least one heating plate 58.1 that has a lower surface substantially parallel to the upper surface S50 of the base 50, and at least one actuator 58.2 (shown schematically) configured to press the lower surface of the heating plate 58.1 against the flexible layer 56. The heating and pressing system 58 is configured to obtain a temperature increase greater than or equal to a melting temperature of the thermoplastic material of the ducts 46 and of the flexible layer 56 at the interface between the flexible layer 56 and the second ends 46.2 of the ducts 46 and to exert sufficient pressure to fuse the interface. The heating and pressing system 58 exerts flat pressure, which helps to simplify the management of the pressure on each duct 46.

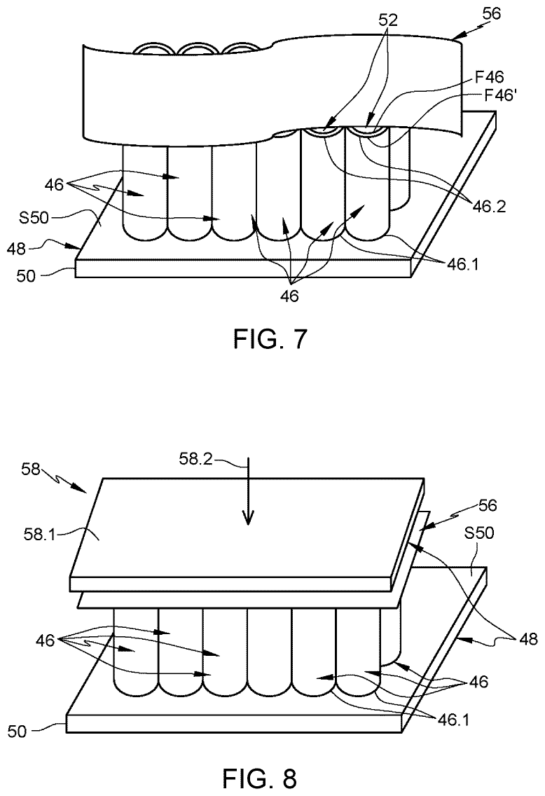

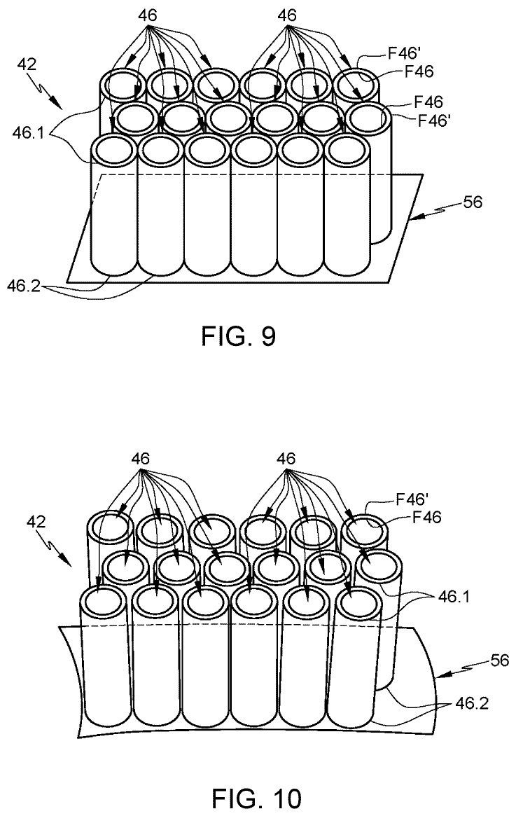

According to one procedure, a method for manufacturing a cellular structure 42 that comprises ducts 46 defining cells comprises a step of manufacturing the ducts 46 from a rigid thermoplastic material, a step of placing the ducts 46 on the tool 48, each duct 46 being fitted onto a core 52 of the tool 48 as illustrated in FIG. 6, and then a step of placing the flexible layer 56 made from a thermoplastic material against the second ends 46.2 of the ducts 46 as illustrated in FIG. 7. Next, the manufacturing method comprises a step of heating and flat-pressing in order to fuse the flexible layer 56 and the second ends 46.2 of the ducts 46 so as to obtain the cellular structure 42, as illustrated in FIG. 8, then a step of demolding the cellular structure 42, as illustrated in FIG. 9, aimed at separating it from the tool 48. This cellular structure 42 made from a thermoplastic material can be formed into a complex geometry, as illustrated in FIG. 10.

A method for manufacturing a sound attenuating panel 38 comprises a step of forming the permeable structure 40 and the solid layer 44. Next, the method comprises a step of placing the cellular structure 42 obtained using the method described above against a first structure among the permeable structure 40 and the solid layer 44 and then a step of placing a second structure different from the first structure among the permeable structure 40 and the solid layer 44 against the first ends 46.1 of the ducts 46 of the cellular structure 42. Finally, the manufacturing method comprises a step of assembling, by co-curing or co-stamping, the assembly made up of the permeable structure 40, the cellular structure 42 and the solid layer 44 in order to obtain the fusing of the first structure with the flexible layer 56 of the cellular structure 42 and of the second structure with the first ends 46.1 of the ducts 46 of the cellular structure 42.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. A method for manufacturing a cellular structure of a sound attenuating panel, the cellular structure comprising a plurality of ducts that define cells, each duct of the plurality of ducts extending between a first end and a second end, the method comprising a step of:
manufacturing the plurality of ducts from a rigid thermoplastic material;
placing the plurality of ducts on a tool that comprises at least one base and, for each duct of the plurality of ducts, a core connected to the base, each duct of the plurality of ducts being fitted onto one of the cores and the first end thereof being in contact with the base;
placing a flexible layer made from a thermoplastic material against the second ends of the plurality of ducts;
heating and flat-pressing to fuse the flexible layer and the second ends of the plurality of ducts so as to form the cellular structure; and,
demolding the cellular structure.

2. The method according to claim 1, wherein each duct of the plurality of ducts has an inner transverse cross-section and a length, and
wherein each core has an identical transverse cross-section to the inner transverse cross-section of a duct holding said each core, or a substantially identical length or a slightly shorter length than the duct holding said each core, or both.

3. The method according to claim 1, wherein the rigid thermoplastic material of the plurality of ducts and the thermoplastic material of the flexible layer both have a melting temperature such that during the heating and flat-pressing, a temperature increase greater than or equal to the melting temperature of the rigid thermoplastic material of the plurality of ducts and of the thermoplastic material of the flexible layer both is produced at an interface between the flexible layer and the second ends of the plurality of ducts, with sufficient pressure being exerted to fuse the interface.

4. A tool for implementing the method according to claim 1, the tool comprising:
at least one base having a substantially flat upper surface;
for each duct of the plurality of ducts of the cellular structure, a core connected to the at least one base; and,
at least one heating and pressing system configured to heat the flexible layer and at least one of the first ends of the plurality of ducts of the cellular structure and to press the flexible layer against the second ends of the plurality of ducts.

5. The tool according to claim 4, wherein the heating and pressing system comprises
at least one heating plate that has a lower surface substantially parallel to the substantially flat upper surface of the at least one base, and
at least one actuator configured to press the lower surface of the at least one heating plate against the flexible layer.

6. The tool according to claim 4, wherein each core has an identical transverse cross-section to an inner transverse cross-section of a duct holding said each core, or a substantially identical or slightly shorter length than the duct holding said each core, or both.

7. A cellular structure of a sound attenuating panel, the cellular structure comprising:
a plurality of ducts that define cells, each duct of the plurality of ducts extending between a first end and a second end; and
at least one flexible layer connected to the second ends of the plurality of ducts,
the plurality of ducts and the flexible layer being made from a thermoplastic material.

8. A sound attenuating panel comprising:
at least one cellular structure according to claim 7,
the at least one cellular structure interposed between a structure permeable to at least one sound wave and a solid layer impermeable to sound waves.

9. A method for manufacturing a sound attenuating panel, the method comprising:
placing at least one cellular structure obtained using the method according to claim 1 against a first structure among a structure permeable to at least one sound wave and a solid layer impermeable to sound waves;
placing a second structure among a structure permeable to at least one sound wave and a solid layer impermeable to sound waves, different from the first structure, against the first ends of the plurality of ducts of the cellular structure; and,
assembling the structure permeable to at least one sound wave, the at least one cellular structure, and the solid layer impermeable to sound waves in order to obtain a fusing of the first structure with the flexible layer of the cellular structure and of the second structure with the first ends of the plurality of ducts of the cellular structure.
